(19) United States
(12) Patent Application Publication
(10) Pub. No.: US 2008/0143923 A1
(43) Pub. Date: Jun. 19, 2008

(54) AREA LIGHT SOURCE

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/834,702

(22) Filed: Aug. 7, 2007

(30) Foreign Application Priority Data
Dec. 19, 2006 (CN) 200610201329.X

(51) Int. Cl. G02F 1/13357

(52) U.S. Cl. 349/69

(57) ABSTRACT

An area light source includes a bottom substrate, a first undulated electrode, a dielectric, a light-emitting layer, a second undulated electrode, and a top substrate stacked in that order. The first and second undulated electrodes have the same shape, configured for receiving a voltage from a power source such that electrons move between the first and second undulated electrodes and strike the dielectric, which results in the light-emitting layer emitting light.

### BACKGROUND

1. Field of the Invention

The present invention relates to area light sources, and particularly to area light sources for use in flat panel display devices such as liquid crystal displays.

2. Description of Related Art

In a liquid crystal display, liquid crystal is used but does not itself radiate light. Instead, the liquid crystal relies on receiving light from a light source, thereby displaying images and data. The light source can be a point light source, a linear light source, or an area light source. The area light source is popularly used because of its advantages, e.g. high lighting uniformity and thinness.

Referring to FIG. 3 and FIG. 4, a conventional area light source is thin and square shaped. The area light source includes a bottom substrate 110, an electrode 120, a dielectric 130, a light-emitting layer 140, an electrode 150, and a top substrate 160 stacked in that order. The electrodes 120, 150 can respectively be a cathode and an anode. The substrates 110, 160 are made of insulating material to protect the electrodes 120, 150. A power source 100 provides an alternating current voltage for the electrodes 120, 150, causing electrons to move between the electrodes 120, 150 with high-speed. The electrons strike the dielectric 130, causing the light-emitting layer 140 to emit light. Increasing the alternating current voltage provided to the electrodes 120, 150 can enhance the light brightness of the area light source. However, too much voltage can damage the electrodes 120, 150.

What is needed, therefore, is an area light source with enhanced light brightness.

### SUMMARY

An area light source for providing light for a liquid crystal display device is provided. In an embodiment, the area light source includes a bottom substrate, a first undulated electrode, a dielectric, a light-emitting layer, a second undulated electrode, and a top substrate stacked in that order. The first and second undulated electrodes have the same shape, configured for receiving a voltage from a power source such that electrons move between the first and second undulated electrodes and strike the dielectric, which results in the light-emitting layer emitting light.

Other advantages and novel features will become more apparent from the following detailed description when taken in conjunction with the accompanying drawings, in which:

### BRIEF DESCRIPTION OF THE DRAWINGS

FIG. 1 is an isometric view of an area light source in accordance with an embodiment of the present invention;

FIG. 2 is a side, enlarged view of the circled portion II of FIG. 1

FIG. 3 is an isometric view of a conventional area light source; and

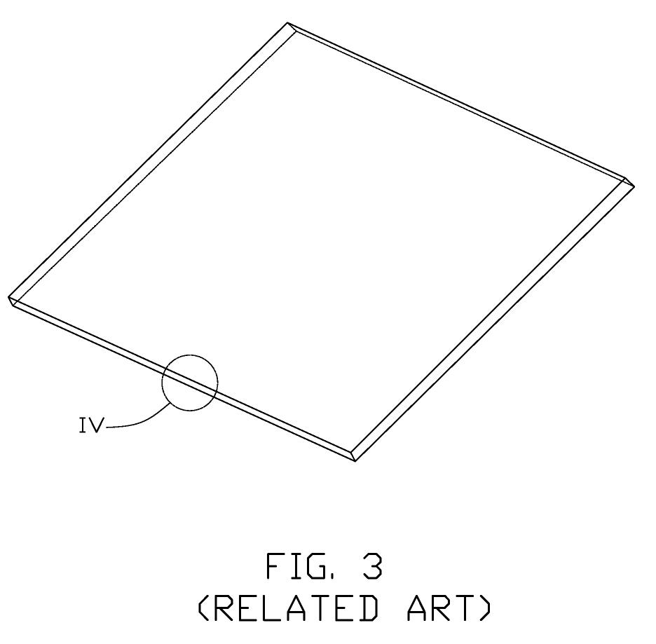

FIG. 4 is a side, enlarged view of the circled portion IV of FIG. 3.

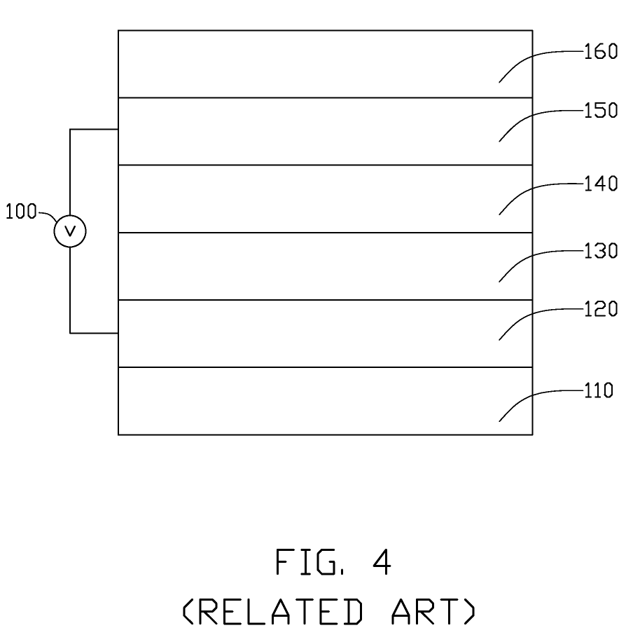

### DETAILED DESCRIPTION

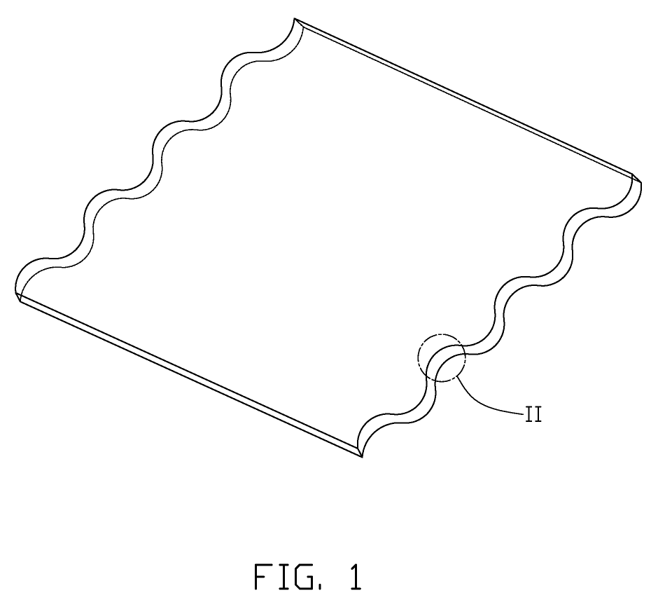

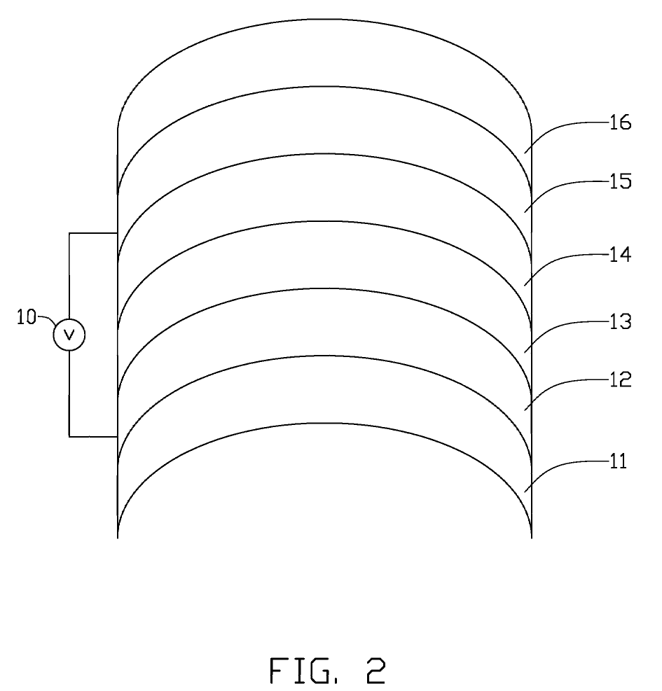

Referring to FIG. 1 and FIG. 2, an area light source for providing light for a liquid crystal display device in accordance with an embodiment of the present invention includes a bottom substrate 11, a first electrode 12, a dielectric 13, a light-emitting layer 14, a second electrodes 5, and a top substrate 16 stacked in that order. The bottom substrate 11, the first electrode 12, the dielectric 13, the light-emitting layer 14, the second electrodes 5, and the top substrate 16 are undulated, with the same shape. The degree of curvature in the undulations of the area light source are chosen such that the light beams provided by the area light source follow a path providing a desired dispersion pattern. The bottom substrate 11 and the top substrate 16 are preferably made of flexible, transparent plastic material. The first electrode 12 and the second electrode 15 can respectively be a cathode and an anode.

A power source 10 provides an alternating current (AC) voltage for the first electrode 12 and the second electrode 15, causing electrons to move between the first electrode 12 and the second electrode 15 with high-speed. The electrons strike the dielectric 13, causing the light-emitting layer 14 to emit light. Because the first electrode 12 and the second electrode 15 are undulated, their surface area is greater than a flat electrode, as found in conventional art, having the same width and height of the first electrode 12 and the second electrode 15. With a constant AC voltage provided by the power source 10, more electrons are generated between the first electrode 12 and the second electrode 15 because of their increased surface areas, which results in more electrical energy being converted to light energy compared to conventional art. Therefore, the light brightness of the area light source is enhanced.

During cycles of the applied AC voltage, equal amounts of electrons alternately flow from the first electrode 12 to the second electrode 15 and vice versa. Therefore, electrical energy generated is uniform throughout the cycles, thus producing consistent light brightness.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An area light source for providing light for a liquid crystal display device, the area light source comprising a bottom substrate, a first undulated electrode, a dielectric, a light-emitting layer, a second undulated electrode, and a top substrate stacked in that order, the first and second undulated electrodes having the same shape, configured for receiving a voltage from a power source such that electrons move between the first and second undulated electrodes and strike the dielectric, which results in the light-emitting layer emitting light.

2. The area light source as claimed in claim 1, wherein the bottom substrate, the dielectric, the light-emitting layer, and the top substrate are undulated, with the same shape as the first undulated electrode.

3. The area light source as claimed in claim 1, wherein the bottom substrate and the top substrate are made of plastic material.

4. The area light source as claimed in claim 1, wherein the first undulated electrode is a cathode, and the second undulated electrode is an anode.

5. An area light source for providing light for a liquid crystal display device, comprising:
two undulated electrodes having the same shape; and
a light-emitting layer located between the two undulated electrodes, for emitting light upon application of a voltage from a power source across the two undulated electrodes.

6. The area light source as claimed in claim 5, wherein one undulated electrode is a cathode, and another undulated electrode is an anode.
